(19) United States
(12) Patent Application Publication
(10) Pub. No.: US 2008/0093418 A1
(43) Pub. Date: Apr. 24, 2008

(54) Multifunctional Reactive Composite Structures Fabricated From Reactive Composite Materials

(76) Inventors: Timothy P. Weihs, Baltimore, MD (US); David M. Lunking, Rockville, MD (US); Ellen M. Heian, Cockeysville, MD (US); Yuwei Xun, Cockeysville, MD (US); Richard Bowman, Whiteford, MD (US); Gary Catig, Baltimore, MD (US); David van Heerden, Baltimore, MD (US); Somasundaram Valliappan, Timonium, MD (US); Omar Knio, Timonium, MD (US); Joseph Grzyb, Greensboro, NC (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/425,663

(22) Filed: Jun. 21, 2006

Related U.S. Application Data
(60) Provisional application No. 60/692,857, filed on Jun. 22, 2005.
(60) Provisional application No. 60/692,822, filed on Jun. 22, 2005.
(60) Provisional application No. 60/740,115, filed on Nov. 28, 2005.

(51) Int. Cl. B23K 31/00

(52) U.S. Cl. 228/101

(57) ABSTRACT

A reactive composite structure having selected energetic and mechanical properties, and methods of making reactive composite structures enabling the construction of complex parts and components by machining and forming of reactive composite materials without compromising the energetic or mechanical properties of the resulting reactive composite structure.

### CROSS-REFERENCE TO RELATED APPLICATIONS

The present application is related to, and claims priority from, U.S. Provisional Application No. 60/692,857 filed on Jun. 22, 2005, which is herein incorporated by reference.

The present application is further related to, and claims priority from, U.S. Provisional Application No. 60/692,822 filed on Jun. 22, 2005, which is herein incorporated by reference.

The present application further is related to, and claims priority from, U.S. Provisional Application No. 60/740,115 filed on Nov. 28, 2005, which is herein incorporated by reference.

### STATEMENT REGARDING FEDERALLY SPONSORED RESEARCH

The United States Government has certain rights in this invention pursuant to Award 70NANB3H3045 supported by NIST through its Advanced Technology Program.

### BACKGROUND OF THE INVENTION

This invention relates to energetic materials. In particular, it concerns methods for fabricating useful assemblies and components from reactive composite materials comprising metals. These components provide energetic output and possess sufficient strength, stiffness, and other mechanical properties to serve structural functions.

Reactive composite materials (RCMs) are useful in a wide variety of applications requiring the generation of intense, controlled amounts of heat or light quickly or from a localized region. Such composite materials typically comprise two or more phases of materials, spaced in a predictable fashion throughout a composite in uniform layers, non-uniform layers, islands, or particles that, upon appropriate excitation, undergo an exothermic chemical reaction that spreads rapidly through the composite structure generating heat and light.

Reactive composite materials (RCMs) and the application of RCMs have been discussed in the above-mentioned patent applications, each of which is herein incorporated by reference. Reactive composite materials may be used to join bodies together, as by welding, soldering or brazing; to initiate other reactions; or as heaters, light sources, interrupters of electrical or other signal paths, propellants, security devices, separators and splitters, sensors, and energetic structural materials—structural components with energetic capabilities.

Energetic structural materials are multifunctional materials that provide structural integrity, mechanical properties (such as strength, ductility, fracture toughness and elastic modulus) similar to those found in metals, and controllable energy release in the same material. An energetic structural material can perform several functions, and can offer several advantages over materials that serve either a purely structural or purely energetic purpose. Energetic structural materials may also provide new functionality and properties not previously seen in either structural materials or energetic materials.

There are a wide variety of applications that can benefit from the inclusion of energetic structural materials to either augment or replace current structural materials or current energetic materials. For example, design and fabrication of explosive bolts, clamps, or other mechanical fasteners that release other components when activated can be simplified if the material utilized provides both mechanical strength and energy release. A rupture membrane in a MEMS device that provides strength against fluid or gas pressure, yet ruptures upon ignition is another example. A linchpin or other one-time release mechanism that can be electrically activated remotely without need for either mechanical action or the presence of an explosive is another possibility, as is a membrane dividing two chemicals in a tank, where the membrane can be ignited and ruptured to allow rapid mixing of the chemicals. In mining, utilizing an energetic structural material as the liner of a shape charge or penetrator designed to fracture and penetrate rock can provide additional energy for rock fracture and potentially reduce the amount of explosive required to penetrate to a given depth.

Security applications, such as the destruction of electronic devices, can be enabled when components such as enclosures for printed circuit boards or hard drive platens are fabricated from a material that can quickly release sufficient energy to disrupt the operation of the device, such as by breaking a circuit board or melting a hard drive.

Finally, applications within military devices are also possible. In particular, structural components such as the housing for electronics, the skin of a missile, fragments launched by a warhead, or casings for munitions can be manufactured from an energetic structural material instead of an inert, purely structural material. Other useful structures can be envisioned for the military as well, such as a bridge that can be easily destroyed after being used to traverse a river or other obstacle. Thus, applications for energetic structural materials range from small MEMS devices to large military devices.

Current structural materials typically possess limited energy release properties. Common structural materials such as steels, aluminum, or composites provide only mechanical strength and stiffness, and do not provide any significant energy release if stimulated with a pulse of thermal or kinetic energy. In fact, these materials may absorb energy and degrade the energetic properties of devices such as munitions and shaped charges. On the other hand, the low cost and ease of formability of these materials, as well as their good mechanical properties, make them difficult to replace.

Conversely, current energetic materials typically have limitations regarding their mechanical properties or their ability to be formed into strong and stiff structural elements. Hydrocarbon-based and nitrogen-based energetic materials, such as many explosives, display low strength and stiffness compared to structural materials such as metals. The formability of many explosives is also limited to casting and extrusion since the sensitivity of the majority of explosives prohibits machining or other standard means of shaping. The mass density of polymer-based energetic materials is significantly less than that of steels (<2 g/cc vs. 7.87 g/cc for steel), a fact that may hinder or prohibit their use as structural members in certain applications such as penetrators, where high mass density is preferred. Currently, the dangers inherent in energetic materials limit their manufacture and restrict their utilization in applications as structural members or components.

To date, two different classes of materials have shown promise as potential energetic structural materials. Powder compacts or powder mixtures in binders such as epoxy are one class of materials. The other class includes reactive composite materials (RCMs), as discussed herein.

Powder-based energetic structural materials consist of micro- or nanometer-scale powders that are well mixed before processing. These powder mixtures are usually either pressed into powder compacts or dispersed into a binder such as an epoxy. However, both powder compacts and powders dispersed in a binder typically display poor mechanical properties. Many powder compacts are brittle or friable and difficult to machine due to their nature as particle agglomerations and their inherent porosity. Powders dispersed in a binder display properties similar to the pure epoxy matrix, with low density, strength, and stiffness as compared to structural materials such as steel, aluminum and titanium. Also of concern are the health and safety hazards associated with toxic or flammable powders. However, the raw materials for powders are low cost and easy to obtain, and are useful in different applications.

Reactive composite materials, in contrast, include energetic materials with significant mechanical properties. In RCMs, two or more different materials that mix and react exothermically, such as aluminum and nickel or titanium and boron carbide, are placed in intimate contact over micro- or nanometer scales. These composite materials are currently fabricated either by vapor deposition or by mechanical formation. The processing method determines to a large extent their mechanical properties. Vapor-deposited RCMs, described in detail in U.S. Pat. No. 6,736,942 to Weihs, et al., possess high strength and stiffness, but generally have low ductility or formability, limiting the shapes and forms into which they can be manufactured. Vapor-deposited RCMs are also technically challenging and expensive to fabricate in large or thick sections, and have to date been available only as thin foils. This is appropriate for many energetic applications, particularly in microelectronics, as shapes can be fabricated by punching and by patterning and lift-off techniques incorporated into the deposition process. Also, vapor-deposited foils are appropriate for applications of planar heat generation, such as joining. Available material geometries and properties impose limitations on the applications of vapor-deposited material on a larger scale, e.g. in macroscopic structural applications requiring large volumes of material, energetic applications requiring high heat per unit volume, or applications requiring the energetic component to have a complex geometry.

Reactive composite materials can also be formed mechanically as foils or sheets via cold-rolling, described in detail in U.S. Provisional Application No. 60/692,822. These mechanically-formed foils or sheets demonstrate better overall ductility and machinability than similar vapor-deposited materials, as well as readily tunable energetic properties, such as reaction velocity, ignition threshold and heat of reaction.

Mechanical formation permits flexibility in the ignition sensitivity and reactivity of RCMs over a very large range. Materials and microstructures can be produced that allow for safe handling and processing at ambient temperature without triggering a self-propagating reaction in the entire structure. For instance, Al/Ni based RCM will not self-propagate at room temperature when the bilayer thickness is on the order of 2 μm or larger. However, heating the sample to near the melting point of aluminum will enable the reaction to occur. If the sample is heated locally, any reaction will be localized and will not propagate into the rest of the structure. The entire sample must be heated above the auto-ignition temperature for the reaction to propagate. This ability to tune the energetic properties through control of the microstructure enables the use of processing previously not possible in energetic materials, such as conventional machining, electro-discharge machining, soldering, brazing, or even welding pieces of RCM together into larger structures.

Another advantage of mechanical formation is that RCM sheets fabricated by cold rolling and wires or rods made by wire forming (e.g. drawing, swaging, or rolling) have a highly oriented microstructure, exhibiting large variations in mechanical properties depending on the orientation of the sample tested. This anisotropy, or texture, may be exploited to produce a wide variety of structural forms, similar to the way the texture of wood may be used.

Constructing useful components or parts from reactive composite structures (RCSs) comprising reactive composite materials (RCMs) requires some particular understanding of the interaction between the energetic properties and the mechanical properties of the RCM utilized within the RCS. The present invention sets forth both RCMs and fabrication techniques that permit the unique mechanical and energetic properties of reactive composite structures (RCSs) to be incorporated into components, parts, and devices.

### BRIEF SUMMARY OF THE INVENTION

Briefly stated, the present invention provides an energetic material, methods of making the same, and fabrication methods that permit the construction of complex parts and components from the energetic material, without compromising either the material's energetic or mechanical properties. The present invention covers the application of RCMs as formable and machinable energetic materials, and the joining and forming necessary to fabricate complex and useful components from bulk energetic materials without igniting the materials.

The present invention sets forth methods for joining RCMs. Selection of the joining method, together with the properties and proportions of the RCM and any joining medium, permits control of both the mechanical properties and the energetic properties of the material. Mechanical properties that can be controlled include but are not limited to yield strength, tensile strength, hardness, fracture toughness, and ductility. The resulting structures exhibit mechanical properties similar to common structural materials such as aluminum and steel and retain the energetic properties of RCMs. Energetic properties so controlled include but are not limited to ignition threshold, auto-ignition temperature, reaction velocity, energy release rate, energy density, gas release, and reaction temperature.

Utilizing methods of the present invention, RCMs and combinations thereof can be formed into useful, complex shapes by conventional machining and forming techniques while remaining safe to handle and process. The materials may be formed into two-dimensional shapes such as simple or complex cutouts from sheet and plate, or into three-dimensional shapes such as beams, shells, trusses, and other useful forms.

Utilizing RCMs as energetic components is simplified by joining two or more pieces of RCM together into a single structure. Current fabrication methods restrict individual pieces of RCM to small sizes and thin gauges, but these limitations can be overcome by methods of the present invention for joining several RCM pieces together along the edges, by laminating thin sheets together to form a thicker bulk material, or by some combination of these two methods. Pieces of RCM may be joined together by one of a variety of joining technologies (such as epoxy, solder, brazing, and welding) to form a thick, large area material with improved strength and stiffness and/or increased energy output.

The foregoing features and advantages of the invention as well as presently preferred embodiments thereof will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 illustrates prior art ignition of an RCM;

FIG. 2A illustrates a tensile specimen machined from a mechanically-formed RCM sheet;

FIG. 2B is a plot of tensile strength vs. bilayer thickness of a Ni—Al reactive composite material;

FIG. 2C is a plot of tensile strength vs. bilayer thickness in CuO+Cu+Al, NiO+Ni+Al, and Pd+Al reactive composite material;

FIG. 2D is a plot of reaction enthalpy vs. bilayer thickness in a Ni—Al reactive composite material;

FIGS. 3A-3D illustrate three-dimensional shapes of edge-joined reactive composite material;

FIG. 4 shows a laminated plate made of stacked layers interspersed with a joining material;

FIG. 5 illustrates a laminated reactive composite material layer cube;

FIG. 6 shows a plate made of stacked reactive composite material layers secured with solder;

FIG. 7 illustrates two layers of reactive composite material mechanically bonded with a ductile joining medium;

FIG. 8 illustrates two sheets of reactive composite material pressed or joined together at the edges;

FIG. 9 shows a mechanically fastened reactive composite material laminate structure;

FIG. 10 illustrates attachment of a reactive composite structure to components in final assembly;

FIG. 11 shows an RCS laminate formed by diffusion bonding of RCM sheets;

FIG. 12A shows a reactive composite structure bonded with inert layers in various configurations including outer layers, inner layers, combinations, and claddings;

FIG. 12B shows a reactive composite structure comprising several pieces of reactive composite material, where the mechanical and reaction properties vary across the dimensions of the reactive composite structure;

FIG. 13 illustrates a reactive composite structure comprising two types of reactive composite material;

FIG. 14 shows a reactive composite structure comprising Ti foil clad with a 2Al+Pd reactive composite material;

FIG. 15 illustrates oriented reactive composite material layers configured to maximize membrane (biaxial) or tensile strength;

FIG. 16 shows reactive composite material wires woven into a mesh or cloth; and

FIG. 17 illustrates ignition by impact of solid object with a reactive composite structure.

Corresponding reference numerals indicate corresponding parts throughout the several figures of the drawings. It is to be understood that the drawings are for illustrating the concepts of the invention and are not to scale.

### DESCRIPTION OF THE PREFERRED EMBODIMENT

The following detailed description illustrates the invention by way of example and not by way of limitation. The description enables one skilled in the art to make and use the invention, and describes several embodiments, adaptations, variations, alternatives, and uses of the invention, including what is presently believed to be the best mode of carrying out the invention.

The present invention sets forth different methods for making reactive composite structures (RCS) having components or bodies which consist of reactive composite materials (RCM), via various assembly, joining, and shaping methods. The reactive composite materials in the reactive composite structure can then be ignited at a subsequent point in time to carry out an intended function of the reactive composite structure. The invention additionally sets forth characteristics of the RCM required to make these methods feasible.

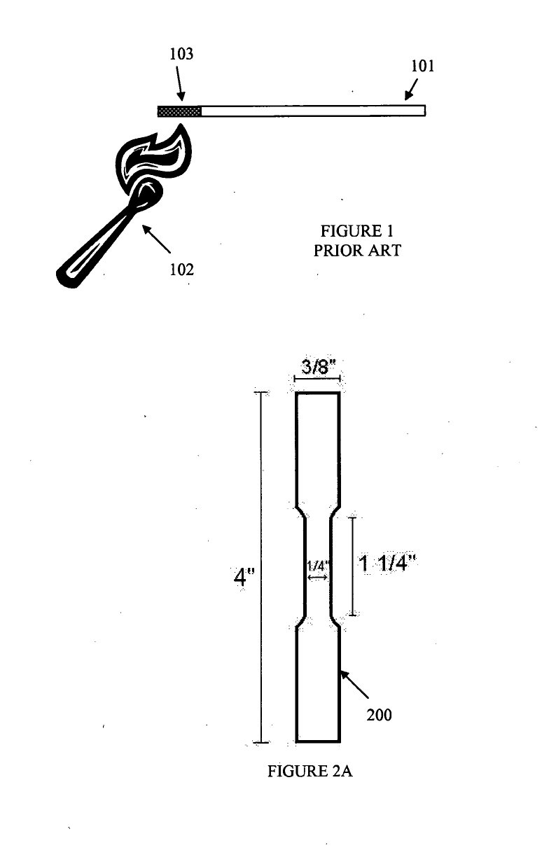

Fundamental to the fabrication methods discussed below is the tunability of RCM properties. One embodiment sets forth an RCM that can be manufactured to be ignition-insensitive at ambient temperature. By varying the type and amount of processing, such as the amount of mechanical deformation, the scale of the microstructure and thus the auto-ignition temperature of the RCM may be precisely controlled. An RCM 101 may be created in which the reaction is self-propagating at a given temperature if a large pulse of energy 102 (thermal or kinetic) is applied locally 103 as shown in FIG. 1. Alternatively, an RCM may be created in which the reaction will ignite locally but not propagate if heated locally but will ignite all at once if heated globally. One example application of a RCM that has been selected to be ignited only by global heating is the casing of an explosive device, where the detonation of the explosive charge is the energy source that globally heats and ignites the RCM.

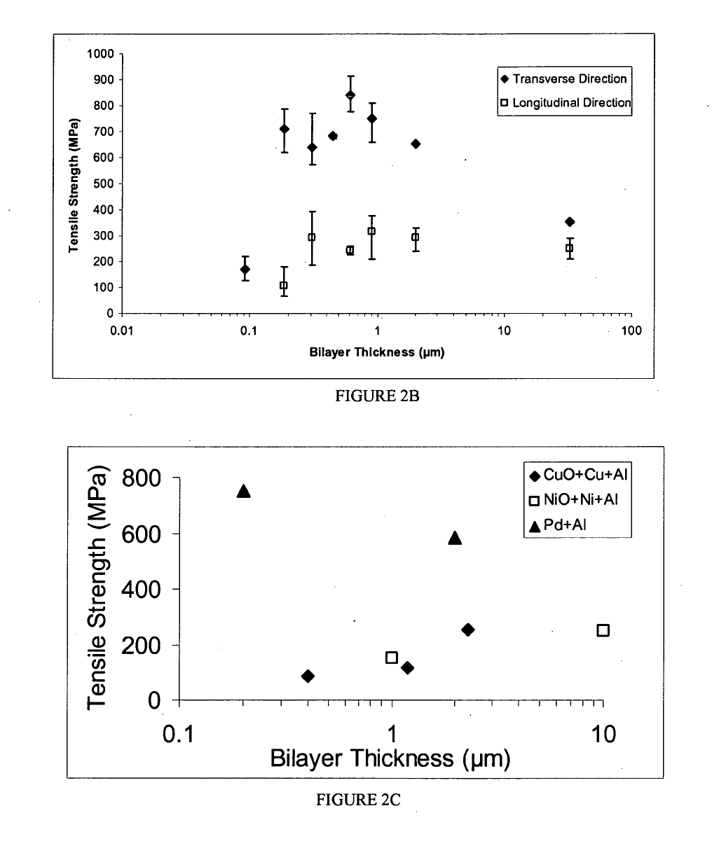

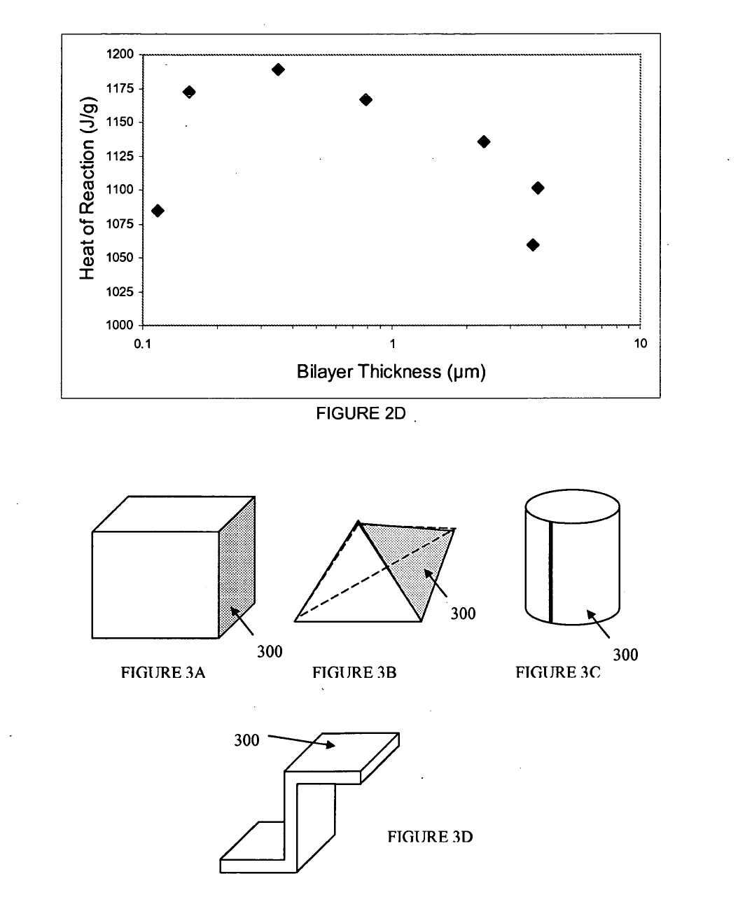

Another embodiment includes control of the mechanical properties of an RCM through control of mechanical deformation. For instance, as mechanical processing increases, the tensile strength of Al/Ni RCM foil increases and then decreases. FIG. 2A is an illustration of a tensile specimen 200 machined conventionally from a mechanically-formed RCM sheet in accordance with ASTM E8-04: Standard Test Methods for Tension Testing of Metallic Materials, subscale specimens. In FIG. 2B, tensile strength vs. bilayer thickness for the specimen 200 is plotted for two sample orientations: along and across the rolling direction, in an Al/Ni rolled foil. FIG. 2C shows tensile strength vs. bilayer thickness for transverse (across the rolling direction) samples of CuO/Cu/Al, NiO/Ni/Al, and Pd/Al foils.

Another embodiment of the invention includes control of the reaction properties of an RCM through control of mechanical deformation. For example, in FIG. 2D the reaction enthalpy of a mechanically formed Al/Ni RCM as measured by Differential Scanning Calorimetry (DSC) is plotted vs. the bilayer thickness of the RCM. The table below lists mechanical properties and heats of reaction for several RCMs along with steel and aluminum for comparison.

| | | | | | | | Non-self- |
|---|---|---|---|---|---|---|---|
| | | | | | | | propagating |
| | | | Measured | | Elongation | Specific | Minimum |
| | Strength | Density | Energy | | to | Strength | Bilayer |
| Material | MPa | g/cm³ | J/g | J/cm³ | Failure % | MPa/g/cm³ | μm |
| Vapor | | | | | | | |
| Deposited | | | | | | | |
| Al/Ni | 320 ± 50 | 5.3 | 1200 | 6360 | — | 58 | 0.5 |
| Mechanically | | | | | | | |
| Formed | | | | | | | |
| Al/Ni | 600-800 | 5.3 | 1250 | 6625 | 5-15 | 113-151 | 0.5 |
| Al/Pd | 550-750 | 7.1 | 1250 | 8875 | 3-10 | 78-53 | 50 |
| NiO—Ni/Al | 150-250 | 6 | 1496 | 8976 | 1-3 | 25-42 | 1 |
| CuO—Cu/Al | 100-200 | 5.6 | 1130 | 6328 | ~3 | 18-36 | 1 |
| Commercial | | | | | | | |
| Products | | | | | | | |
| Steel-1015 | 420 | 7.9 | — | — | 39 | 53 | — |
| rolled | | | | | | | |
| Al 6061-T6 | 310 | 2.7 | — | — | 12 | 115 | — |

In another embodiment, a sheet or foil RCM 300, which may be flat, curved, bent, or otherwise formed, is joined at the edges to produce three-dimensional structures, including but not limited to I-, L-, and box-beams, trusses, and shells. A few examples are shown in FIGS. 3A-3D, while other examples should be evident to anyone skilled in the art. As will be described in more detail below, joining methods may include epoxy, soldering, brazing, welding, or mechanical methods such as rivets, clamps, or bolts.

In another embodiment of the present invention, a laminated structure consisting of two or more pieces of RCM 401 can be fabricated by stacking pieces of RCM 401 into a single RCS 400 with a joining medium 402, such as an epoxy or solder, between the RCM pieces 401. This enables fabrication of structures and geometries that might otherwise be difficult or costly to manufacture by another means.

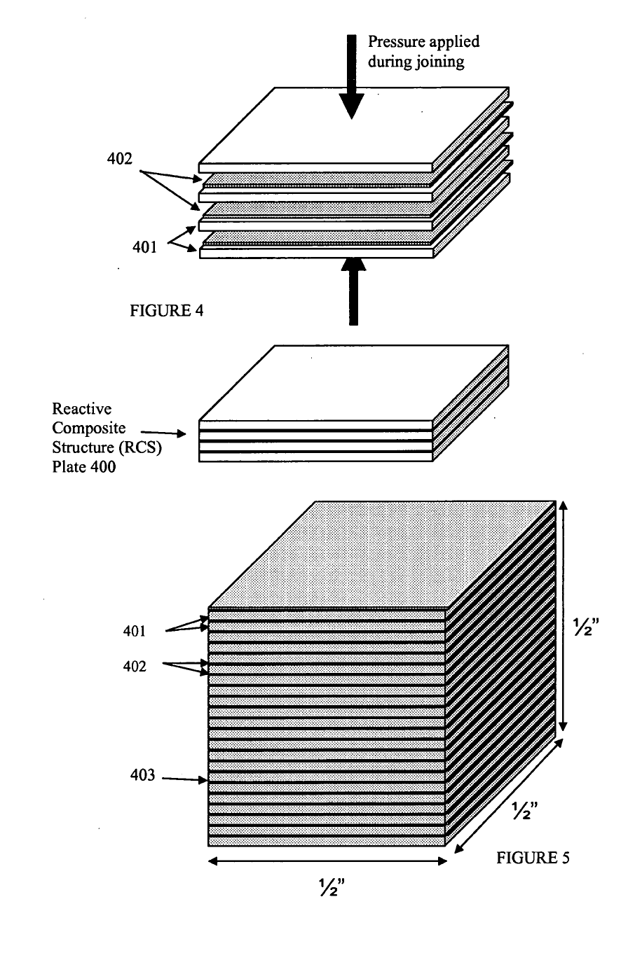

One approach to joining two or more pieces of RCM 401 is by a joining material 402 such as an epoxy or glue. In this embodiment, a thick laminated plate 400 composed of sheets of RCM 401 can be joined under pressure with the joining material 402, such as EPON 826 resin with EPON 3223 hardener, manufactured by Miller-Stephenson, as shown in FIG. 4. This laminated plate 400 can then be machined using a standard milling machine and bits to achieve a desired finished shape. For example, FIG. 5 is an illustration of an RC cube 403 having dimensions of ½ inch by ½ inch by ½ inch, made by gluing together 21 layers of an Al/Ni RCM 401 with the above-mentioned joining material 402, to form a plate 400 which is ½″ thick. Each layer was 0.5 mm thick and ⅝″ by ⅝″ in size. The plate 400 was cured under pressure, then machined to the desired final cube shape 403, and finally coated with a layer of epoxy for additional cohesion. In one example, cubes 403 were made from RCMs 401 having an average bilayer thickness ranging from 0.18 μm to 33 μm.

In a related embodiment, the properties or the thickness of the joining medium 402, for instance epoxy, may be varied to produce different mechanical or energetic properties in an RCS. The properties and thickness of the joining medium 402 may also be varied from layer to layer within one RCS 400 to provide more insulation or less between layers of RCM 401, or to vary the energy density, reactivity, or other properties across the thickness of the reactive composite structure 400.

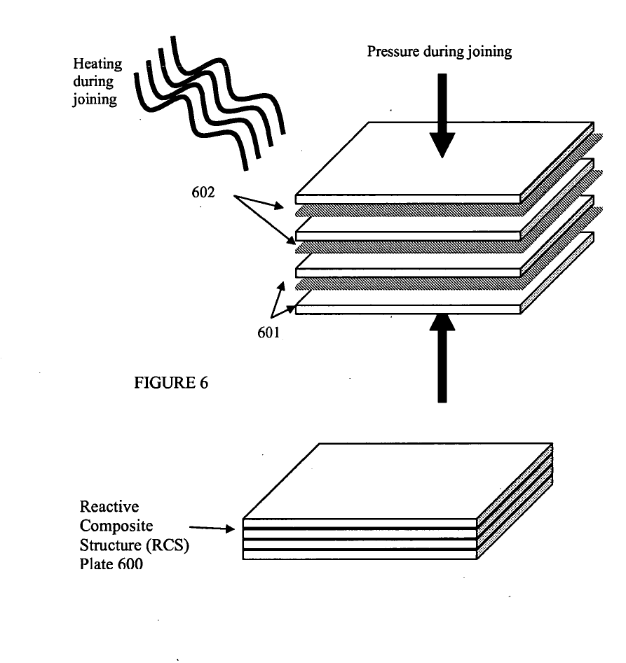

In another embodiment of this invention, shown in FIG. 6, a thick RCS plate 600 is composed of sheets of RCM 601 joined together with a joining medium 602 such as a solder or braze. For example, one such suitable solder is CerroTru (bismuth-tin, melts at 281° F.). A solder or braze material 602 may be applied to a sheet of RCM 601 via any standard application method, for example, by heating the sheet of RCM 601 above the melting point of the solder or braze 602 alloy as shown in FIG. 6. Adhesion may be improved by etching the surface of the RCM 601 with a flux or acid or by physical scrubbing during heating. The main difference between a solder and braze joining medium 602 is the temperature required to melt the medium 602.

For example, 21 squares of Al/Ni based RCM 601, each with a bilayer thickness of approximately 20 μm and an overall thickness of 500 μm, were alternately layered with 50 μm sheets of a CerroTru foil joining medium 602. This resulting stack was dipped into a bath of Kester 715 flux and reflowed under clamping pressure in an oven at 450° F. for one hour. This process yielded a laminated structure 600 of RCM pieces as shown in FIG. 6. Similarly, sheets of RCM 601 could be soldered together at the edges to produce a larger RCS 600 in sheet form.

In an alternate embodiment, a thick plate RCS may be fabricated by welding or hot pressing two or more RCM sheets together. Similarly, RCM pieces could be welded at the edges to create three-dimensional shapes. As discussed above, the RCM can be designed with a coarse microstructure that is not self-propagating, allowing the material to be locally welded without changing the structural or energetic properties of the overall components. This selection enables a variety of welding options, such as but not limited to, TIG welding, gas flame welding, ultrasonic welding, friction stir welding, etc.

In a related embodiment, the RCM pieces may be actively cooled to prevent the pieces from becoming hot enough to ignite or anneal during a welding procedure. This cooling may be effected by clamping the RCM between pieces of metal to conduct heat away, or by holding the RCM in a bath of chilled water or liquid nitrogen, or by other means. Because RCMs typically possess high thermal conductivities, excess heat near a weld may be readily drawn away without igniting the entire structure.

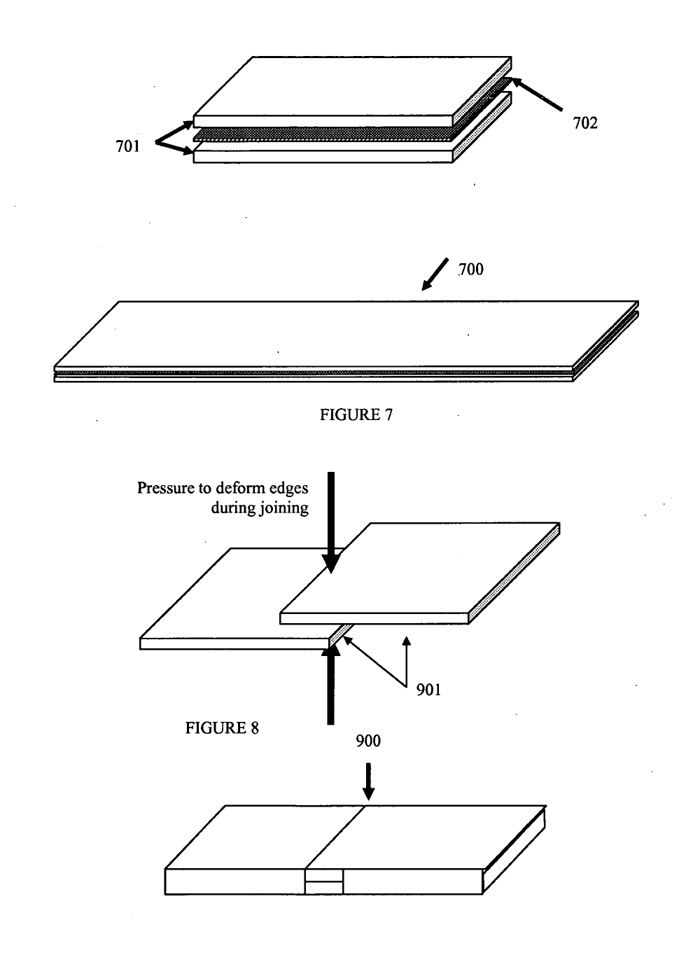

In another embodiment, shown in FIG. 7, two or more pieces of RCM 701 are joined together by cold-rolling them with a soft and ductile joining layer 702 between them. Example ductile layers 702 include, but are not limited to, aluminum, copper, tin, and indium. For example, a 7.6 μm sheet of Al 1145-O was sandwiched between two 500 μm layers of Al/Ni based RCM 701 with an average bilayer thickness of 500 nm. This sandwich was then cold rolled to an overall thickness reduction of approximately 35%. The result was a single, well-bonded RCS 700 thicker than each of the starting materials, as shown in FIG. 7.

In an alternate embodiment, shown in FIG. 8, the edges of the cold-rolled RCM 901 can be pressed or mechanically deformed together to create a larger RCS 900 of two or more pieces of RCM 901. One edge each of two or more pieces of RCM 901 can be mechanically pressed, hot pressed, or rolled together until sufficient deformation is achieved to ensure bonding between the materials over a small portion of their surface areas as is shown in FIG. 8.

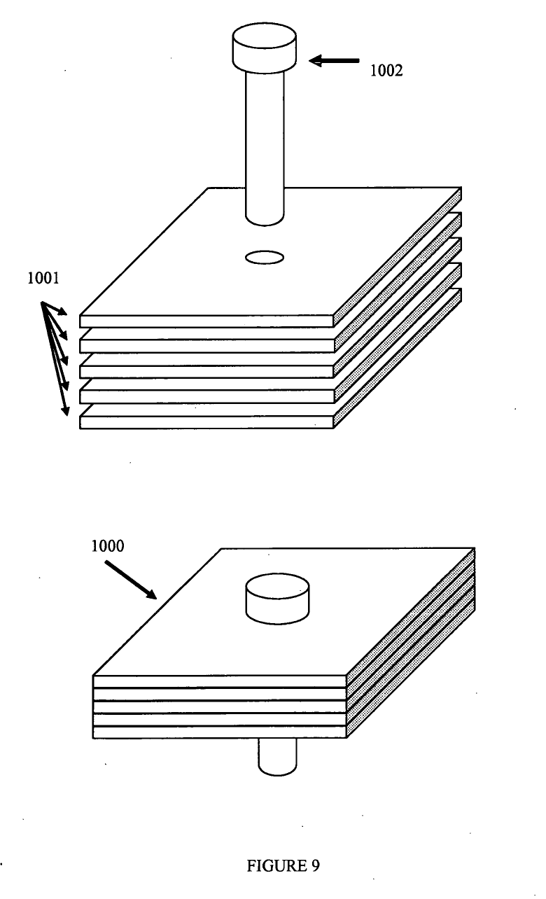

In yet another embodiment, shown in FIG. 9, a composite structure 1000 of two or more pieces of RCM 1001 may be fabricated by utilizing a mechanical fastener 1002, such as a rivet, bolt, screw or clamp, to hold two or more pieces of RCM 1001 together. This method may be used to fabricate larger surface areas by joining smaller pieces together at their edges, or to fasten a laminated structure by joining two or more pieces together with a large overlapping area, similar to laminated steel structures, such as is shown in FIG. 9.

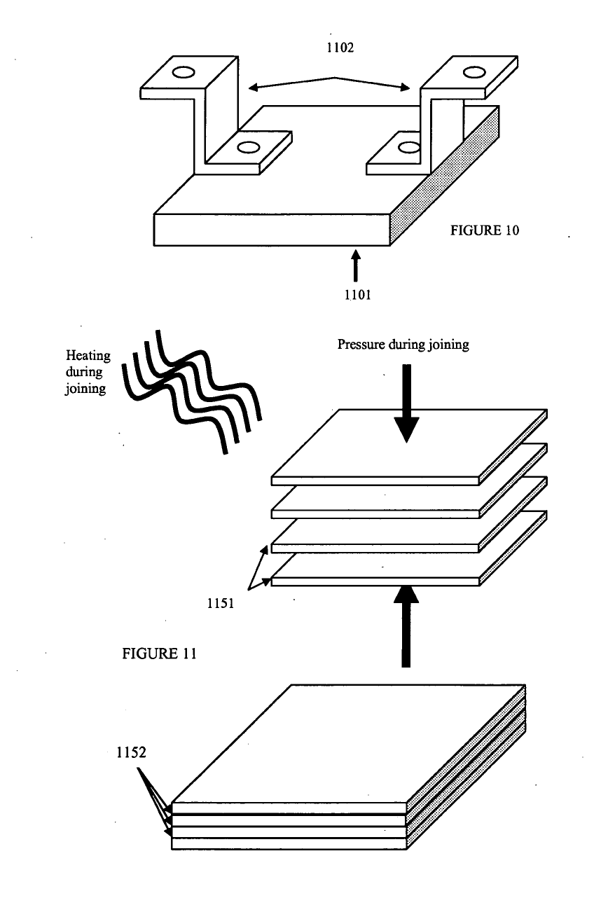

In another embodiment of the invention, shown in FIG. 10, a composite RCS 1101 may comprise two or more separate RCSs 1102 that are joined to each other or to an inert material by one of the above methods. Alternatively, one or more layers of an RCM may be added to one or more RCSs by one or more of the above mentioned methods to create a larger RCS. Additionally, one or more layers of RCM may join two or more RCSs together by one or more of the above mentioned methods. By this method, subassemblies such as 1102 may be joined together to form larger components or devices 1101. Mechanical fasteners, solder, welding, epoxy, and other methods may all be used to install RCS parts 1102 in the assemblies 1101 in which they are part of, in a manner similar to the methods described above for attaching RCMs together.

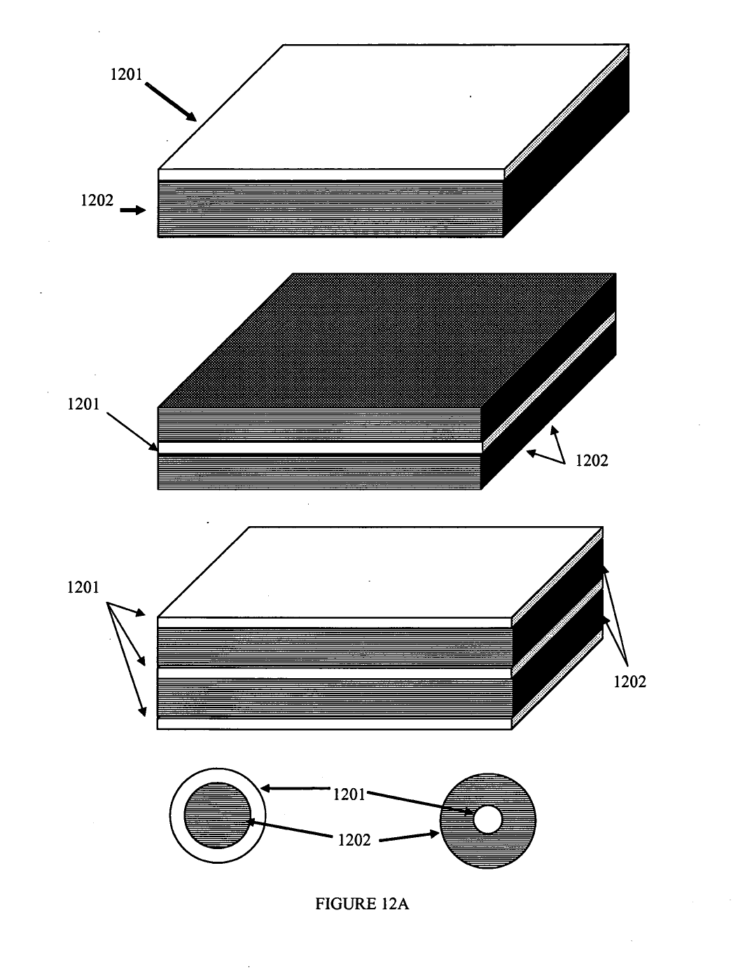

In another embodiment of this invention, shown in FIG. 11, two or more layers of RCM 1151 may be joined together by diffusion bonding. For example, two or more layers of RCM 1151 may be heated under pressure (uniaxial or isostatic) until there is sufficient atomic diffusion at interfaces 1152 to bond the layers together. This method may be used to join RCMs 1151 together at the edge, with an overlap, or over a bulk area to create a thermally bonded laminate. Alternatively, a joining medium such as a metal, ceramic or polymer can be inserted between the RCMs 1151 to facilitate bonding as previously described.

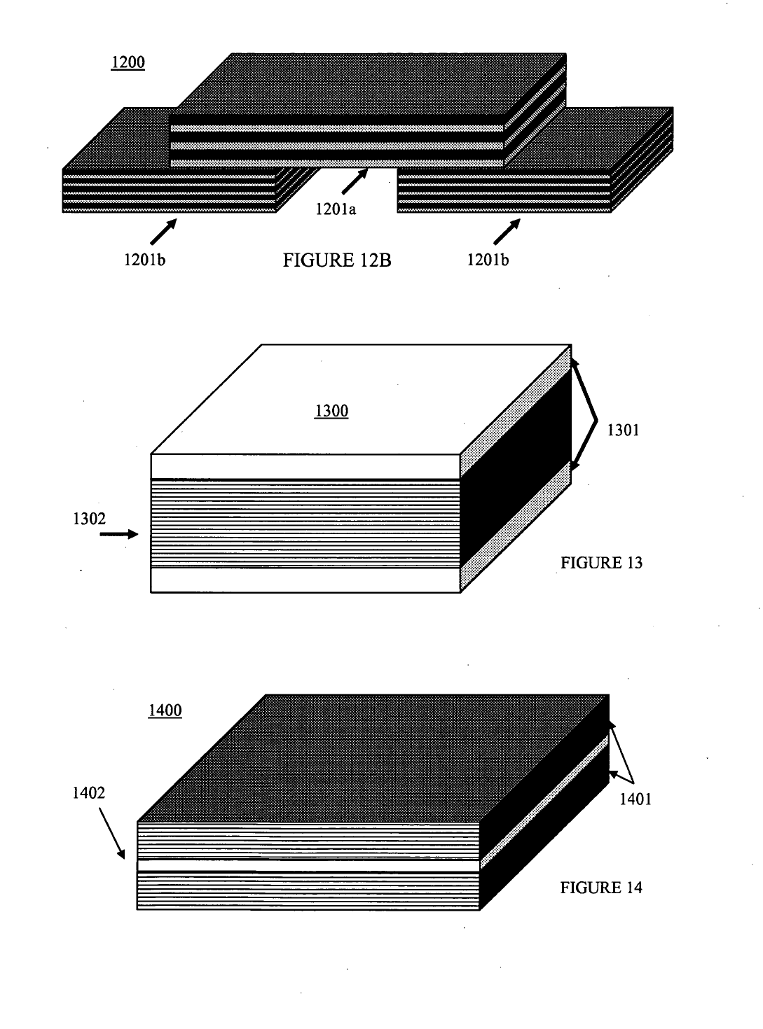

In another embodiment of this invention, one or more layers of material 1201 that are not an RCM but which could be a metal, ceramic, polymer, or combination, may be joined to one or more pieces of an RCM 1202 to alter various properties, including but not limited to reaction stability, mechanical strength and ductility, energy output, emissivity, gas output, and density. The non-RCM layers 1201 may be added to one or both surfaces of a planar RCM 1202, as a laminated layer 1201 between layers of RCM 1202, or some combination of the two, such as are illustrated in FIG. 12A. This non-RCM layer 1201 may be joined by any of the means discussed previously. A non-RCM layer 1201 may also be on the outside or at the core of a cylinder, particularly in the case of wires or rods, where the inert layer 1201 could be included during the wire-drawing or swaging process.

Added to the outside surface of an RCS 1202, a non-RCM layer 1201 can tune both the mechanical and reactive properties of the RCS. A layer of non-reactive material 1201 on the surface will help to stabilize the RCS, increasing the threshold needed for ignition. A thick outer layer of ductile non-RCM material 1201 over a brittle RCM 1202 will also prevent breakage of the component during manufacture, handling, or use. Alternatively, a hard outer layer of non-RCM material 1201 will increase the surface hardness of the material.

Energetic properties may also be tailored by addition of an outer non-RCM layer 1201. Cladding an RCM 1202 with a material 1201 that burns in air, such as, but not limited to, titanium, aluminum, magnesium, epoxy, or a hydrocarbon, can increase the amount of heat generated by the RCS after the RCM 1202 is ignited. Cladding an RCM 1202 with a material 1201 with a low melting point, for instance indium, and/or a high heat of fusion, will alter the peak temperature reached at the surface and the overall energy density. Other cladding materials 1201 may be selected to alter properties such as electromagnetic emissivity, gas output (with a layer of solid hydrocarbon, for instance), thermal conductivity, RF radiation sensitivity, electrostatic discharge sensitivity, electrical resistivity, and magnetic susceptibility.

For example, 30 μm of Al/Ni RCM vapor-deposited on a 0.005″ thick sheet of polyethylene may be wrapped around a cylinder of flexible solid rocket propellant. The reactive multilayer is then used to ignite the propellant, but before this occurs, the polymer backing offers considerable structural support to the cylinder, preventing it from bending during the rest of the assembly process.

Added to the interior of an RCS, a non-RCM layer 1201 can readily tune the mechanical properties of the RCS. Joined by any of the means above, a mechanically strong or ductile interior layer helps overcome some limitations of RCMs, such as the low ductility of vapor-deposited RCM 1202. Likewise, other properties, such as but not limited to strength, stiffness, density, thermal conductivity, electrical resistivity, ESD sensitivity, and magnetic properties, can be tailored by addition of a non-RCM layer 1201 to the interior of the RCS. Simultaneously adding non-RCM layers 1201 to both the interior and exterior of an RCS enables independent control of many of the above listed properties.

The energetic properties of RCSs may be varied across a component 1200 by using layers of RCM with different ignition thresholds, reaction velocities, or heats of reaction. For instance, a laminated RCS 1200 formed from individual layers of RCM may have its reaction properties vary across its thickness, while a complex shell or truss may have structural or energetic properties that vary from one end of the RCS 1200 to the other, such as shown in FIG. 12B, by incorporating pieces of RCM 1201a and 1201b having different properties. In another example, cladding an RCM with a higher ignition threshold, such as a material with a larger bilayer or lower heat of reaction, near the surface of a complex RCS will raise the overall ignition threshold and may increase the fracture toughness of the overall RCS, while retaining the ease of ignition and brittle nature of the core. Conversely, cladding a more reactive material with a lower ignition threshold onto a material with a higher ignition threshold will raise the general reactivity of a structure to that of the surface material.

For example, two pieces 1301 of Al/Pd RCM 50 μm thick, with an average bilayer thickness of 200 nm, were clad onto the surfaces of an Al/Ni-based RCM 1302 which was 300 μm thick, with an average bilayer thickness greater than 500 nm (and thus not self-propagating at room temperature). The resulting structure 1300, as illustrated in FIG. 13, will self-propagate and react fully when ignited in air, while the bare Al—Ni-based RCM 1302 will not.

In a variation shown in FIG. 14, a 7 μm thick foil 1402 of titanium, which burns in air, was clad on each side with a 50 μm layer 1401 of RCM with 2Al+Pd chemistry. The resulting composite 1400 was noticeable stiffer than the original 2Al+Pd material. When ignited, the entire sample melted and burned white hot in air, a property not seen before in this particular Al/Pd-based RCM 1401.

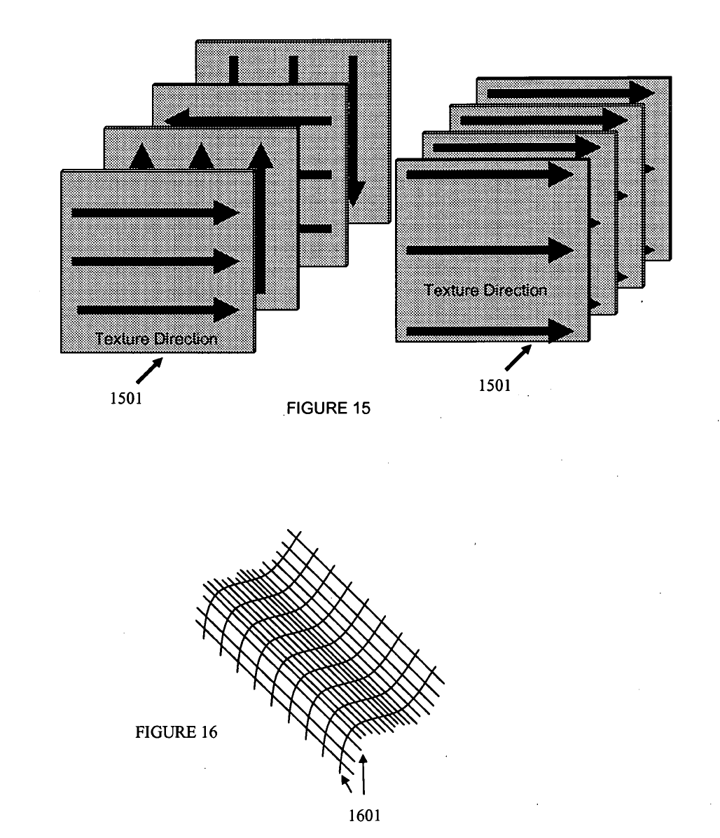

In another embodiment of the present invention, illustrated in FIG. 15, the mechanical properties of the RCS parts may be varied by exploiting the textured microstructure of rolled RCM sheets 1501. Aligning the textured directions in each layer 1501 of a laminated material allows for increased strength and faster reaction velocities in one direction, at the cost of strength and velocity in the perpendicular directions. Randomizing or alternating the texture direction in each layer 1501 produces a material similar to plywood, where the net texture is zero because the contribution of each layer 1501 is offset by the presence of another, perpendicular layer 1501. The resulting strength of the material is lower in any given direction than a similar material with aligned textures, but is higher in all other in-plane directions. In short, material texturing and anisotropy is an advantage in a laminated structure, allowing properties to be tuned over a greater range.

In another embodiment, an RCM 1601 formed as a wire may be woven into mesh or cloth, as shown in FIG. 16, resulting in a flexible but strong energetic material that could be used as a backing for other components, as a skin for an assembly, or for other purposes. Random tangles and three-dimensional structures may also be created from RCMs.

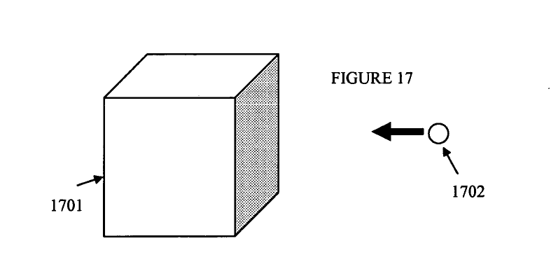

Another embodiment of the present invention is a method for igniting very stable RCSs 1702 by propelling them into a solid object 1701 at very high velocities, as shown schematically in FIG. 17. The kinetic energy of the RCS 1702 is converted into thermal energy, raising the temperature of the entire RCS 1702 to the ignition point, causing simultaneous reaction and release of energy. Alternatively, it is possible that the desired moment of ignition is after the impact of the RCS 1702 with the solid object 1701. In this case, the stability of the RCS 1702 must be high, and a timing circuit or other external ignition source may be used to ignite the RCS 1702 at the appropriate moment.

As various changes could be made in the above constructions without departing from the scope of the invention, it is intended that all matter contained in the above description or shown in the accompanying drawings shall be interpreted as illustrative and not in a limiting sense.

1. A method for manufacture of a reactive composite structure, comprising:
providing a plurality of reactive composite materials; and
joining said plurality of reactive composite materials to form a reactive composite structure.

2. The method of claim 1 further including the step of selecting a scale of a microstructure within at least one of said plurality of reactive composite materials; and
wherein an auto-ignition temperature of at least one of said plurality of reactive composite materials is associated with said selected scale.

3. The method of claim 2 wherein said scale of said microstructure is selected such that ignition of at least one of said reactive composite materials is self-propagating responsive to a locally applied energy pulse.

4. The method of claim 2 wherein said scale of said microstructure is selected such that ignition of at least one of said reactive composite materials is self-propagating in response to a globally applied energy pulse.

5. The method of claim 1 wherein at least one of said reactive composite materials has a microstructure in which ignition is not self-propagating in response to a locally applied energy pulse.

6. The method of claim 1 further including the step of controlling mechanical deformation in said reactive composite materials.

7. The method of claim 1 wherein said plurality of reactive composite materials are joined to produce a three-dimensional structure.

8. The method of claim 7 wherein said three-dimensional structure is selected from a set of three-dimensional structures including a rectangular solid, a cylinder, an I-beam, an L-beam, a box-beam, a truss, and a shell.

9. The method of claim 1 wherein said plurality of reactive composite materials are joined with at least one joining medium to produce a laminate structure.

10. The method of claim 9 wherein said at least one joining medium is selected from a set of joining mediums including epoxy, glue, solder, or braze.

11. The method of claim 9 wherein said at least one joining medium is selected to alter a property of said reactive composite structure, said property selected from a set of properties including mechanical properties and energetic properties.

12. The method of claim 1 wherein said plurality of reactive composite materials are joined by at least one joining process selected from a set of joining processes including mechanical bonding, epoxy bonding, soldering, brazing, welding, and diffusion bonding.

13. The method of claim 1 wherein said reactive composite materials are cooled during said joining step to maintain said reactive composite materials below an ignition temperature.

14. The method of claim 1 wherein said plurality of reactive composite materials are joined by a mechanical process.

15. The method of claim 1 wherein said joining step includes mechanically deforming a ductile joining material to secure said plurality of reactive composite materials.

16. The method of claim 1 wherein said joining step includes disposing a ductile joining layer between said plurality of reactive composite materials; and
cold-rolling said reactive composite materials together with said ductile joining layer.

17. The method of claim 1 wherein said plurality of reactive composite materials are joined by at least one mechanical fastener.

18. The method of claim 1 wherein at least one of said plurality of reactive composite materials is a reactive composite structure.

19. The method of claim 1 further including the step of providing at least one inert material; and
wherein said joining step further includes joining said inert material with said plurality of reactive composite materials.

20. A product made by the method of claim 1.

21. A method for manufacture of a reactive composite structure from at least one reactive composite material and at least one inert material, comprising the step of:
joining said reactive composite material to said inert material.

22. The method of claim 21 wherein said inert material is selected from a set of inert materials including metals, ceramics, and polymers.

23. The method of claim 21 wherein said inert material is selected to alter a property of said reactive composite structure, said property selected from a set of properties including ignition temperature, reaction stability, mechanical strength, ductility, energy output, emissivity, gas output, thermal conductivity, electrical resistivity, electrostatic discharge sensitivity, radio-frequency radiation sensitivity, magnetic susceptibility, and density.

24. The method of claim 21 wherein said reactive composite material and said inert material are joined by at least one joining process selected from a set of joining processes including epoxy bonding, soldering, brazing, welding, and diffusion bonding.

25. The method of claim 21 wherein said reactive composite material and said inert material are joined by a mechanical process.

26. The method of claim 21 wherein said reactive composite material and said inert material are joined along at least one surface to produce a laminate structure.

27. The method of claim 26 further including the application of a joining medium between said inert material and said reactive composite material.

28. A product produced by the method of claim 21.

29. A reactive composite structure comprising:
at least one component, said component including a reactive composite material and having a shape chosen for a particular purpose.

30. The reactive composite structure of claim 29 wherein said at least one component is selected to have a material characteristic, said material characteristic selected from a set of material characteristics including ignition temperature, reaction stability, mechanical strength, ductility, fracture toughness, energy output, gas output, electrical resistivity, magnetic susceptibility, and density.

31. The reactive composite structure of claim 29 wherein said at least one component has a microstructure of a scale such that an ignition of said reactive composite material is self-propagating responsive to a locally applied energy pulse.

32. The reactive composite structure of claim 31 wherein said components are joined by at least one joining process selected from a set of joining processes including mechanical bonding, mechanical deformation, cold rolling, epoxy bonding, soldering, brazing, welding, and diffusion bonding.

33. The reactive composite structure of claim 31 wherein said components are joined with at least one joining medium.

34. The reactive composite structure of claim 33 wherein said at least one joining medium is selected from a set of joining mediums including epoxy, glue, solder, braze, and ductile materials.

35. The reactive composite structure of claim 33 wherein said at least one joining medium is selected to alter a property of said reactive composite structure, said property selected from a set of properties including mechanical properties and energetic properties.

36. The reactive composite structure of claim 31 wherein said components are joined by at least one mechanical fastener.

37. The reactive composite structure of claim 31 wherein said components each have at least one different property, said property selected from a set of properties including ignition temperature, reaction velocity, heat of reaction, mechanical strength, ductility, fracture toughness, energy output, gas output, electrical resistivity, magnetic susceptibility, and density.

38. The reactive composite structure of claim 31 wherein said components are joined to produce a three-dimensional structure.

39. The reactive composite structure of claim 38 wherein said three-dimensional structure is selected from a set of three-dimensional structures including a rectangular solid, a cylinder, an I-beam, an L-beam, a box-beam, a truss, and a shell.

40. The reactive composite structure of claim 31 wherein each of said components has a microstructure texture direction; and
wherein said microstructure texture directions of adjacent components are aligned parallel to each other.

41. The reactive composite structure of claim 31 wherein each of said components has a microstructure texture direction; and
wherein said microstructure texture directions of adjacent components are aligned perpendicular to each other.

42. The reactive composite structure of claim 31 wherein each of the said components has a microstructure texture direction; and
wherein said microstructure texture directions of adjacent components are mis-aligned.

43. The reactive composite structure of claim 29 wherein said at least one component has a microstructure of a scale such that ignition of said reactive composite material is not self-propagating responsive to a locally applied energy pulse.

44. The reactive composite structure of claim 29 further including at least one additional component formed from a reactive composite material secured to said at least one component.

45. The reactive composite structure of claim 29 further including at least one body of inert material secured to said at least one component.

46. The reactive composite structure of claim 45 wherein said inert material is selected from a set of inert materials including metals, ceramics, and polymers.

47. The reactive composite structure of claim 45 wherein said inert material is selected to alter a property of the reactive composite structure, said property selected from a set of properties including ignition temperature, reaction stability, mechanical strength, ductility, fracture toughness, energy output, gas output, electrical resistivity, magnetic susceptibility, and density.

48. The reactive composite structure of claim 45 wherein said inert material is secured to said at least one component via at least one joining process selected from a set of joining processes including mechanical bonding, cladding, vapor deposition, epoxy bonding, soldering, brazing, welding, and diffusion bonding.

49. The reactive composite structure of claim 45 wherein said inert material serves as a joining medium.

50. The reactive composite structure of claim 29 wherein said at least one component includes a plurality of strands of reactive composite material.

51. The reactive composite structure of claim 29 wherein at least one property of the reactive composite structure is varied across at least one dimension of the reactive composite structure, said property selected from a set including mechanical and energetic properties.

52. The reactive composite structure of claim 51 further comprising at least one body of an inert material secured to the at least one component.

53. The reactive composite structure of claim 51 further comprising at least a second component, each of said components having at least one different property selected from a set including mechanical and energetic properties.

54. A method for igniting a reactive composite structure, comprising:
propelling said reactive composite structure into a target object; and
whereby said propelled reactive composite structure is ignited by conversion of kinetic energy of said propelled reactive composite structure into thermal energy upon impact with said target object.

55. A method for igniting a reactive composite structure, comprising:
propelling said reactive composite structure into a target object; and
subsequent to impact between said reactive composite structure and said target object, igniting said reactive composite structure with an ignition source.

56. A projectile, comprising:
a body, wherein a portion of said body is a reactive composite structure.

57. The projectile of claim 56 wherein said body further includes an ignition source, said ignition source configured to ignite said reactive composite structure.

58. The projectile of claim 57 further including a timer operatively coupled to said ignition source, said ignition source further configured to ignite said reactive composite structure in response to a signal from said timer.
